(19) United States
(12) Patent Application Publication
(10) Pub. No.: US 2026/0084959 A1
(43) Pub. Date: Mar. 26, 2026

(54) METHODS AND SYSTEMS FOR MITIGATING CARBON FOULING IN A FEEDSTOCK REACTOR

(71) Applicant: EKONA POWER INC., Burnaby (CA)

(72) Inventors: Donald William KENDRICK, Bellevue, WA (US); Kenneth William KRATSCHMAR, Vancouver (CA); Scott Cameron GRAY, New Westminster (CA); Mehran DADSETAN, Toronto (CA); Alireza SETAYESHGAR, Coquitlam (CA)

(21) Appl. No.: 19/332,833

(22) Filed: Sep. 18, 2025

Related U.S. Application Data
(60) Provisional application No. 63/696,989, filed on Sep. 20, 2024.

(51) Int. Cl. C01B 3/24; B01J 6/00

(52) U.S. Cl. CPC C01B 3/24; B01J 6/008; C01B 2203/0266; C01B 2203/1235

(57) ABSTRACT

A hydrocarbon feedstock is decomposed by pyrolysis in a reactor to produce reaction products including solid carbon. At least some of the solid carbon builds up within the reactor. Buildup of the solid carbon within the reactor is removed by combusting a fuel. The fuel may be a portion of the hydrocarbon feedstock itself, or some other fuel.

### CROSS-REFERENCE TO RELATED APPLICATION

This application claims priority from U.S. Provisional Patent Application Ser. No. 63/696,989 filed on Sep. 20, 2024, the entire disclosures of which are part of the disclosure of the present application and are hereby incorporated by reference in their entireties.

### FIELD

The present disclosure relates to feedstock pyrolysis and in particular to methods and systems for mitigating carbon fouling in a feedstock reactor.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by raising the temperature of the feedstock gas to a point at which the chemical bonds of the elements of the feedstock gas break down.

Pyrolysis may be achieved by bringing the feedstock gas into thermal contact with a hot fluid. In one example, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

Carbon fouling is a common problem in feedstock reactors. Carbon fouling refers to the buildup of carbon deposits on surfaces inside the reactor. This phenomenon commonly occurs when incomplete combustion or decomposition of hydrocarbon molecules leads to the formation of carbon (coke) deposits, and can lead to significant flow blockage that impacts the operability of the reactor, as well as other issues.

Conventional carbon black reactors that are focused on soot production as their ultimate goal deal with carbon fouling through energy-intensive means such as the use of steam or water soot blowers that reduce the reactor's overall performance. Additionally, the added cleaning modules further increase the overall control architecture's complexity.

Maintaining a sufficiently high process stream velocity can help transport carbon particulates downstream and out of the reaction train. However, this approach is often at odds with the desire to maximize residence time (the duration of exposure to high temperature within the reactor) needed for soft carbon production and for maximizing carbon yields. Achieving longer residence times at higher velocities typically requires extending reactor length, which in turn increases heat loss and capital expenditure. A solution that enables higher local process velocities without requiring longer reactor sections would therefore be advantageous.

### SUMMARY

According to a first aspect of the disclosure, there is provided a method of mitigating carbon fouling in a feedstock reactor, comprising: decomposing by pyrolysis a hydrocarbon feedstock in the reactor to produce reaction products including solid carbon, wherein at least some of the solid carbon builds up within the reactor; and removing buildup of the solid carbon within the reactor by combusting a fuel.

Decomposing the hydrocarbon feedstock may comprise: continuously flowing the hydrocarbon feedstock through the reactor; and injecting a hot fluid into the flow of hydrocarbon feedstock, wherein heat is transferred from the hot fluid to the hydrocarbon feedstock to cause decomposition of the hydrocarbon feedstock.

The fuel may be a first fuel, and injecting the hot fluid may comprise: combusting a second fuel to generate combustion products; and injecting the combustion products into the flow of hydrocarbon feedstock.

The first and second fuels may be different fuels.

The composition of the first fuel may be the same as the composition of the second fuel.

Combusting the fuel may comprise combusting the fuel in one or more combustors connected to the reactor to generate combustion products that flow from the one or more combustors and into the reactor.

Combusting the fuel in the one or more combustors may comprise combusting the fuel in the presence of air or O₂.

Combusting the fuel may comprise combusting the fuel in one or more combustors connected to the reactor downstream of a location at which the hot fluid is injected into the flow of hydrocarbon feedstock.

The fuel may be a first fuel. Continuously flowing the hydrocarbon feedstock may comprise continuously flowing the hydrocarbon feedstock along an axial flow channel of the reactor. Injecting the hot fluid into the flow of hydrocarbon feedstock may comprise: flowing a second fuel into a vortex flow field offset from, and connected to, the axial flow channel, wherein the vortex flow field is configured to cause the second fuel entering the vortex flow field to flow in a vortex inside the vortex flow field; and combusting the second fuel in the vortex flow field to generate combustion products that are forced to flow out of the vortex flow field and mix with the hydrocarbon feedstock flowing along the axial flow channel.

The first and second fuels may be different fuels.

The composition of the first fuel may be the same as the composition of the second fuel.

The reaction products may further include syngas, and combusting the fuel may comprise combusting at least some of the syngas.

The method may further comprise, prior to decomposing the hydrocarbon feedstock, pre-heating the hydrocarbon feedstock. Decomposing the hydrocarbon feedstock may comprise mixing the pre-heated hydrocarbon feedstock with an oxidant to trigger combustion of a first portion of the pre-heated hydrocarbon feedstock to generate combustion products, wherein heat is transferred from the combustion products to a second portion of the pre-heated hydrocarbon feedstock and causes decomposition of the second portion of the pre-heated hydrocarbon feedstock.

Removing buildup of the solid carbon may comprise: loading the reactor with fresh hydrocarbon feedstock, wherein the fresh hydrocarbon feedstock is the fuel; sealing the reactor with the fresh hydrocarbon feedstock loaded therein; combusting the fresh hydrocarbon feedstock in the sealed reactor; and after combusting the fresh hydrocarbon feedstock, depressurizing the reactor to remove the buildup of solid carbon.

Loading the reactor with the fresh hydrocarbon feedstock may comprise: pre-heating the fresh hydrocarbon feedstock; and loading the reactor with the pre-heated hydrocarbon feedstock. Combusting the fresh hydrocarbon feedstock may comprise mixing the pre-heated hydrocarbon feedstock with an oxidant to trigger combustion of the pre-heated hydrocarbon feedstock.

Sealing the reactor may comprise: monitoring the buildup of solid carbon within the reactor; and sealing the reactor in response to the monitored buildup exceeding a threshold.

Removing the buildup of solid carbon within the reactor may comprise: monitoring the buildup of solid carbon within the reactor; and combusting the fuel in response to the monitored buildup exceeding a threshold.

Removing the buildup of solid carbon may comprise pulsing the combustion of the fuel to excite one or more acoustic modes of the reactor to remove the buildup of the solid carbon within the reactor.

The reactor may comprise one or more natural acoustic modes, and pulsing the combustion of the fuel may comprise pulsing the combustion of the fuel at one or more frequencies selected to excite the one or more natural acoustic modes.

Pulsing the combustion of the fuel may comprise: monitoring the buildup of the solid carbon within the reactor; and pulsing the combustion of the fuel in response to the buildup exceeding a threshold.

Monitoring the buildup may comprise monitoring a pressure drop across the reactor, and pulsing the combustion of the fuel may comprise pulsing the combustion of the fuel in response to the pressure drop exceeding a threshold.

Pulsing the combustion of the fuel may comprise: mixing a flow of the fuel with an oxidant; and pulsing the flow of the fuel during the mixing.

Pulsing the combustion of the fuel may comprise: mixing the fuel with a flow of an oxidant; and pulsing the flow of the oxidant during the mixing.

Removing the buildup of solid carbon may further comprise: flowing fresh pre-heated hydrocarbon feedstock through the reactor, wherein the fresh pre-heated hydrocarbon feedstock is the fuel; and flowing an oxidant into the flow of pre-heated hydrocarbon feedstock, wherein a portion of the pre-heated feedstock is combusted in response to coming into thermal contact with the oxidant.

Removing the buildup of solid carbon may further comprise pulsing the flow of the oxidant.

The oxidant may be air or O₂.

At least one of the one or more acoustic modes may be based on at least one choke point introduced in the reactor.

The method may further comprise introducing the at least one choke point to the reactor, and pulsing the combustion of the fuel may comprise pulsing the combustion of the fuel to excite the at least one acoustic mode based on the at least one introduced choke point.

According to a further aspect of the disclosure, there is provided a feedstock reactor comprising: a burner for combusting a fuel and an oxidant to generate combustion products; a choke downstream of the burner to accelerate a flow of the combustion products into a reaction chamber downstream of the choke; and a computer controller configured to: control valving to control a flow of a hydrocarbon feedstock into the reaction chamber, wherein at least some of the feedstock, in response to mixing with the combustion products, is decomposed by pyrolysis into reaction products including solid carbon, wherein some of the solid carbon builds up within the reaction chamber; and control valving to control a flow of an oxidant into the reaction chamber to mix the oxidant with the hydrocarbon feedstock such that at least some of the hydrocarbon feedstock combusts in response to mixing with the oxidant and thereby removes buildup of the solid carbon.

According to a further aspect of the disclosure, there is provided a feedstock reactor comprising: a burner for combusting a fuel and an oxidant to generate combustion products; a choke downstream of the burner to accelerate a flow of the combustion products into a reaction chamber downstream of the choke; one or more offboard combustors connected to the reaction chamber; and a computer controller configured to: control valving to control a flow of a hydrocarbon feedstock into the reaction chamber, wherein at least some of the feedstock, in response to mixing with the combustion products, is decomposed by pyrolysis into reaction products including solid carbon, wherein some of the solid carbon builds up within the reaction chamber; and control the one or more combustors to combust a fuel-oxidant mixture in each combustor to generate combustion products that flow into the reaction chamber and remove the buildup of solid carbon.

This summary does not necessarily describe the entire scope of all aspects. Other aspects, features, and advantages will be apparent to those of ordinary skill in the art upon review of the following description of specific implementations.

### DRAWINGS

Embodiments of the disclosure will now be described in detail in conjunction with the accompanying drawings of which:

FIG. 1 is a schematic diagram of a steady-flow feedstock reactor including off-board combustors, according to an embodiment of the disclosure;

FIGS. 2A and 2B are schematic diagrams of a steady-flow feedstock reactor including valves that are open when the reactor is under normal operation (2A) and that are closed when the reactor is undergoing a cleaning cycle (2B), according to an embodiment of the disclosure;

FIG. 3 is a schematic diagram of a feedstock reactor that may undergo cleaning by controllably pulsing the fuel flow, according to an embodiment of the disclosure;

FIG. 4 is a schematic diagram of a feedstock reactor including choke points, according to an embodiment of the disclosure;

FIG. 5 is a schematic diagram of a further steady-flow reactor according to an embodiment of the disclosure; and

FIG. 6 is a flow diagram of a method of method of mitigating carbon fouling in a feedstock reactor, according to an embodiment of the disclosure.

### DETAILED DESCRIPTION

The present disclosure seeks to provide novel methods and systems for mitigating carbon fouling in a feedstock reactor. While various embodiments of the disclosure are described below, the disclosure is not limited to these embodiments, and variations of these embodiments may well fall within the scope of the disclosure which is to be limited only by the appended claims.

Throughout this disclosure, unless otherwise specified, a reaction chamber should be interpreted as encompassing any volume or zone within which pyrolysis of a feedstock is intended to occur. Therefore, a reaction chamber includes the reaction chamber of a steady-flow reactor, and refers to the zone or volume along which feedstock is continuously flowed. In addition, a reaction chamber includes the reaction chamber of a constant-pressure reactor, and refers to the zone or volume contained by the sealed pressure vessel of such a reactor.

Generally, embodiments of the disclosure relate to methods and systems for performing pyrolysis of a feedstock gas, such as natural gas or a hydrocarbon gas, such as methane. Examples of such methods of pyrolysis, as well as example feedstock gas reactors that may be used for such pyrolysis, are described in further detail in Patent Cooperation Treaty (PCT) Publication No. WO 2020/118417, herein incorporated by reference in its entirety.

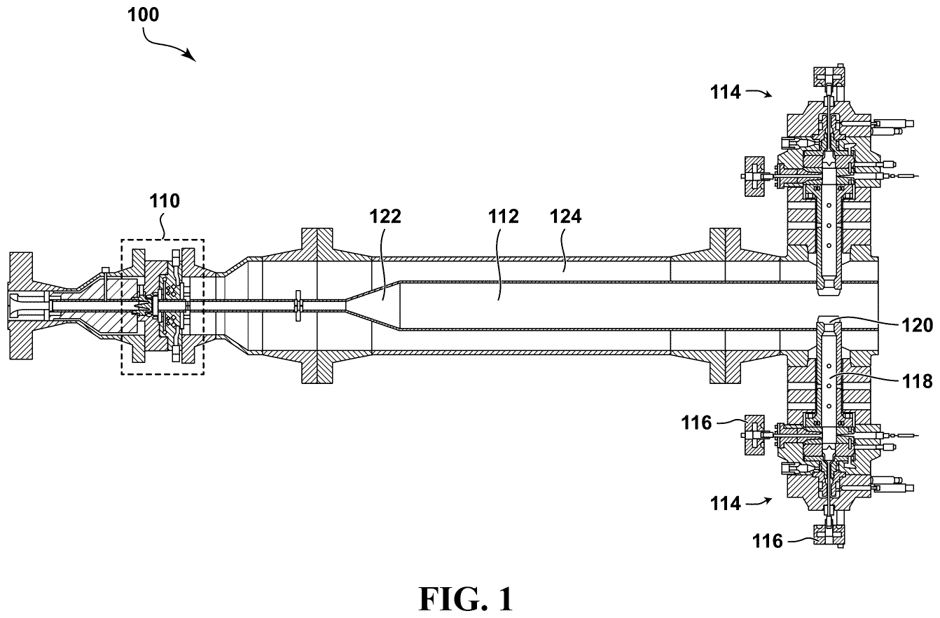

In addition to being applicable to constant-pressure reactors (for example, as described in WO 2020/118417), the methods of mitigating carbon fouling, as described herein, are applicable to steady-flow reactors, examples of which are described in further detail throughout this disclosure. For instance, turning to FIG. 1, there is shown an example of a steady-flow feedstock reactor according to an embodiment of the disclosure.

Generally, as described in further detail below, the steady-flow reactor of FIG. 1 comprises off-board combustors positioned downstream of a trapped vortex combustor module. A purpose of these combustors is to create pressure pulses resulting from the combustion process. These pulses may be used to remove carbon buildup within the reactor.

To prevent excessive pressures from entering the reactor, the combustors may operate with air as the oxidizer and recycled syngas as the fuel. Using air instead of pure oxygen helps minimize post-combustion pressures, thereby protecting the ceramic lining of the reactor. To further safeguard the ceramic refractory, a protective liner made from a strong, high-temperature material (such as a high-nickel steel) may be employed. This liner may provide an additional protective layer while withstanding the elevated temperatures within the reactor.

Positioning the combustors downstream of the trapped vortex combustor module may also help prevent strong shock waves from entering the combustion chambers, reducing the risk of flame instabilities. Since the combustors do not contribute to pyrolysis, they need not operate continuously; instead, they may be fired periodically or only when carbon fouling is detected (for example, when monitored carbon buildup exceeds a threshold).

Looking at FIG. 1 in more detail, feedstock reactor 100 comprises a trapped vortex combustor module 110 (or simply a “trapped vortex combustor”) for mixing a hydrocarbon feedstock with hot combustion products generated by the combustion of a fuel. Examples of trapped vortex combustors are described in Patent Cooperation Treaty Publication No. WO 2024/124325, herein incorporated by reference in its entirety.

Generally, as described in more detail in WO 2024/124325, an example trapped vortex combustor includes an axial flow channel and a vortex flow field offset from, and connected to, the axial flow channel. The vortex flow field is radially offset from the axial flow channel and, for example, may extend partially or fully in a circumferential direction around the axial flow channel. The vortex flow field is configured to cause fluid entering the vortex flow field to flow in a vortex inside the vortex flow field. For example, the vortex flow field should have an appropriate aspect ratio to naturally trap the vortical flow formed by the shear layer off upstream edges/corners of the vortex flow field. In addition, further flow of the fluid into the vortex flow field may ensure that the vortical flow is maintained within the vortex flow field. A hydrocarbon feedstock is caused to flow into and along the axial flow channel via one or more feedstock inlets. In addition, the fuel (e.g., methane) and an oxidant (e.g., pure oxygen) are caused to flow into the vortex flow field via one or more fluid inlets. As a result of the fuel-oxidant mixture entering the vortex flow field, the fuel-oxidant mixture flows in a vortex inside the vortex flow field, as described above. While the fuel-oxidant mixture is flowing inside the vortex flow field, the fuel-oxidant mixture is caused to combust, for example by activating one or more igniters inside the vortex flow field. Combustion of the fuel-oxidant mixture produces one or more hot combustion product gases (or simply “combustion products”). The combustion products flow into the axial flow channel and mix with the feedstock flowing along the axial flow channel. Mixing of the feedstock with the combustion products causes thermal energy to be transferred from the combustion products to the feedstock, thereby decomposing the feedstock into its constituent components. In the case of methane, for example, the decomposition takes the following form:

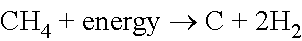

Other reaction products may include H₂, H₂O, CO, CO₂, and O₂.

According to some embodiments, the feedstock that is delivered to trapped vortex combustor 110 may be pre-heated using, for example, a heat exchanger.

As shown in FIG. 1, the pyrolysis occurs in a reaction chamber 112 which is shielded using an insulating refractory 124 such as a ceramic. A metal liner 122 is also provided between reaction chamber 112 and insulating refractory 124 to provide additional protection.

Downstream of trapped vortex combustor 110 are provided a pair of opposed off-board combustors 114 connected to reaction chamber 112. While two combustors are shown in FIG. 1, any number of combustors may be used. Each combustor 114 comprises oxidant (e.g., air) and fuel valves 116 to receive a fuel-oxidant mixture which may then be combusted inside a combustion chamber 118 of the combustor 114. According to some embodiments, the fuel-oxidant mixture may be provided to the combustor 114 in a pre-mixed state instead of being mixed within the combustor 114.

The combustion of the fuel-oxidant mixture generates pressure pulses that travel out of combustors 114 via nozzles 120 and into reaction chamber 112, removing carbon buildup from the interior surfaces of reaction chamber 112. When using air as the oxidant, the nitrogen in the air is heated during the combustion and rapidly expands, contributing to the formation of pressure pulses.

The operation of combustors 114 may be controlled using a suitable controller comprising circuitry. For example, combustors 114 may be fired in response to a pressure sensor (not shown) detecting that a pressure drop within reaction chamber 112 has increased above a threshold (the pressure drop being due to excess carbon buildup). Alternatively, combustors 114 may be fired according to a preset schedule, such as an algorithmically determined schedule.

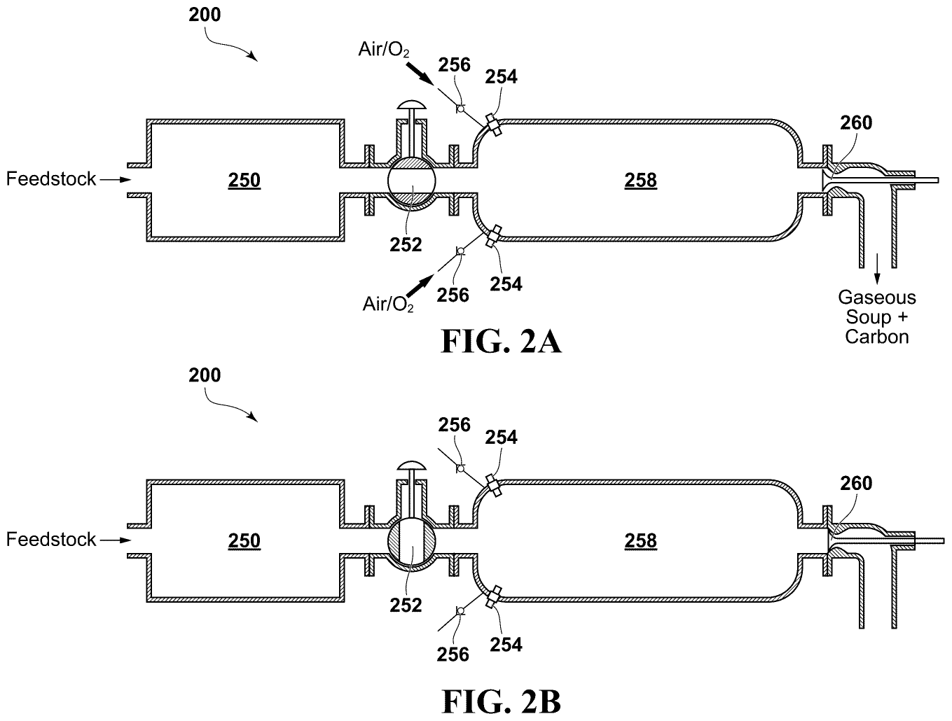

In an alternative embodiment (FIGS. 2A and 2B), carbon buildup within a reactor 200 may be mitigated or cleaned by periodically closing the reaction chamber and effectively turning the steady-flow process into a constant-volume process.

As can be seen in FIG. 2A, a hydrocarbon feedstock is delivered to a pre-heater 250 which pre-heats the feedstock, for example up to 900° C. The feedstock then flows through an open inlet valve 252 and into a reaction chamber 258. An oxidant (such as air or pure oxygen) is delivered to reaction chamber 258 via check valves 256 and mixes with the pre-heated feedstock. Igniters 254 are used to trigger combustion of some of the pre-heated feedstock mixed with the oxidant. The heat of combustion drives decomposition by pyrolysis of un-combusted pre-heated feedstock, forming reaction products. The reaction products then flow out of reaction chamber 258 via an open outlet valve 260. Once reactor 200's temperature has sufficiently increased, igniters 254 may no longer need to be triggered and instead the pre-heated feedstock may auto-ignite in response to being mixed with the oxidant.

During normal operation of reactor 200, solid carbon produced by the pyrolysis of the feedstock will gradually form on surfaces of reaction chamber 258, and may reduce the efficiency of the process. A pressure sensor (not shown) may be used to detect excessive carbon buildup, for example by detecting that a pressure drop within reaction chamber 258 has increased above a threshold (the pressure drop being due to excess carbon buildup). In response to detecting excess carbon buildup, reactor 200 may enter a cleaning cycle (FIG. 2B) in which inlet valve 252 and outlet valve 260 are closed, sealing reaction chamber 258. Once sealed, the pressure within reaction chamber 258 increases dramatically as a result of continued combustion of pre-heated feedstock within reaction chamber 258. Outlet valve 260 is then opened (not shown in FIG. 2B), and the resulting rapid depressurization causes carbon build-up within reaction chamber 258 to be mitigated (for example, coke or carbon buildup on the internal walls of reaction chamber 258 is flushed out of reaction chamber 258 via outlet valve 260). Inlet valve 252 is then opened and reactor 200 may proceed back to normal operation.

According to still further embodiments, mitigation of carbon fouling may be achieved by leveraging acoustic modes of the reactor. Natural excitation of such modes is a common phenomenon in confined combustors (e.g., in rockets and gas turbines), where geometric confinement and flow restrictions promote resonance. Such modes may take one or more of three forms:
1. Longitudinal modes—associated with the axial length scale of the chamber.
2. Transverse modes—associated with characteristic dimensions orthogonal to the flow direction.
3. Circumferential modes—spanning the periphery of wetted flow diameters or annular combustion chambers.

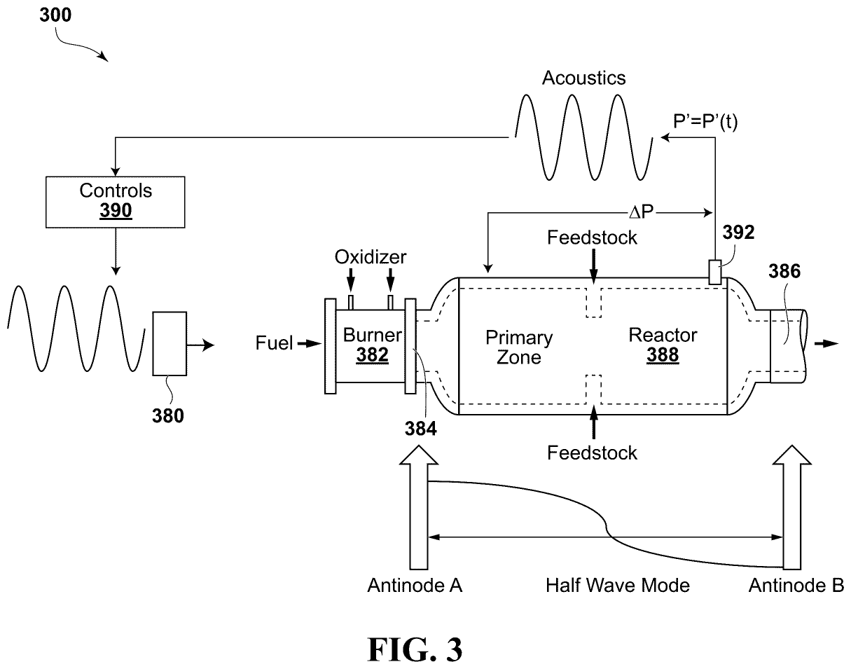

Therefore, according to embodiments of the disclosure, carbon fouling may be mitigated by operating the reactor in a pulsed mode to deliberately excite the reactor's acoustic modes, as now described in connection with FIG. 3 which shows another embodiment of a reactor 300 for reacting a feedstock. In this embodiment, a fuel is combusted in a burner 382 which receives the fuel as well as an oxidant. The flow of fuel into burner 382 is controlled by a high-speed flow valve 380 (such as a solenoid valve) under control of a controller 390 comprising circuitry. The combustion products generated within burner 382 flow, via an inlet 384, into a reaction chamber 388 into which a hydrocarbon feedstock (which may have the same composition as the fuel) is delivered, and which may be pre-heated. The combustion products mix with the feedstock and drive decomposition of the feedstock by pyrolysis, as described above. The reaction products that are formed by the pyrolysis are extracted from reaction chamber 388 through an outlet 386.

As can be seen schematically in FIG. 3, reaction chamber 388 exhibits a particular acoustic mode defined by the positions of antinodes A and B at the inlet 384 and outlet 386 of reaction chamber 388. By controlling the flow of fuel into burner 382, this acoustic mode may be excited and may assist in removing carbon buildup from the walls of reaction chamber 388. In particular, the flow of fuel into burner 382 may be controlled by controller 390 which operates flow valve 380. Controller 390 may control flow valve 380 to pulse the flow of fuel into burner 382. The pulsing may be set to a frequency which corresponds to the natural acoustic mode of reaction chamber 388, and may therefore excite this acoustic mode. Although less desirable, instead of pulsing the flow of fuel, the flow of oxidant may be pulsed instead.

As described above in connection with FIGS. 1, 2A, and 2B, in order to initiate cleaning of reaction chamber 388 (i.e., in order to remove carbon fouling from within reaction chamber 388), a pressure sensor 392 may be used to detect a pressure drop within reaction chamber 388. When the pressure drop is determined to have increased above a threshold, controller 390, which is communicatively coupled to pressure sensor 392, may trigger pulsing of the fuel flow to excite the natural acoustic mode of reaction chamber 388 and thereby initiate cleaning. Once cleaned, controller 390 may control flow valve 380 such that the flow of fuel into burner 382 returns to a steady-state.

According to some embodiments, artificial acoustic modes may be created by deliberately introducing one or more constrictions or choke points within the reaction chamber. Such choke points, which may be introduced downstream of the reaction chamber's primary zone, may be used to develop an acoustically “hard” system that promotes longitudinal acoustic mode excitation. Associated Mach numbers are preferably above 0.5 to enable a “hard” acoustic boundary condition, wherein the distance between choke points dictates the resultant mode shape and excitation frequency. The fundamental mode will be a half-wavelength mode as both the upstream and downstream choke points are pressure anti-nodes.

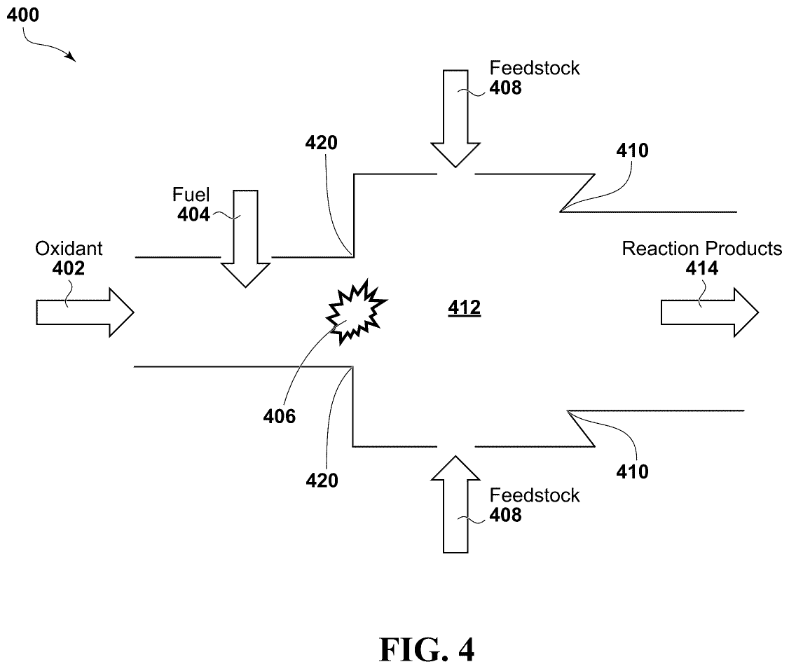

For example, referring to FIG. 4, there is schematically shown another embodiment of a feedstock reactor 400 comprising an upstream choke point and a downstream choke point to engineer an acoustic mode in the reactor.

Reactor 400 comprises a reaction chamber 412 into which a feedstock 408 is delivered. A flow of an oxidant 402 is caused to mix with a flow of fuel 404, and the mixture is then combusted 406. The combustion generates combustion products that drive decomposition of feedstock 408 into reaction products 414, as described above. Reaction products 414 are extracted from an outlet of reactor 400. Reaction chamber 412 includes an upstream constriction or choke point 420 and a downstream constriction or choke point 410 that introduce an acoustic mode that may be excited when operating reactor 400. In particular, the generation of combustion products may be pulsed (for example, by pulsing the flow of fuel 404 or oxidant 402) at a particular frequency that excites the acoustic mode created by the presence of choke points 410 and 420. This excitation may facilitate cleaning of reaction chamber 412 by removing carbon buildup or fouling within reaction chamber 412. Reactor 400 may include damping (for example, acoustic liners or the like) in order to prevent run-away limit cycles during the excitation of the acoustic mode.

According to some embodiments, the upstream choke point may be formed by a flame holder that generates the flame that triggers the combustion.

Throughout the embodiments described herein, operation of the reactor's various valves may be controlled by a suitable controller (such as a microprocessor) comprising circuitry. The controller (not shown), or some other controller, may control the loading and unloading of the reaction chamber by controlling valves and compressors or similar devices, for example. The controller may also control the injection of the fuel and oxidant into the combustors and/or into other locations of the reactor.

According to some embodiments, oxidant, a combination of oxidant and fuel, or combustion products may be injected into the flowing feedstock stream in an intermittent or pulsed manner, such that local auto-ignition of the surrounding feedstock produces transient fluctuations in temperature and pressure. These pressure pulses can generate rapid variations in mass flow rate within the reactor, helping to dislodge or clear carbon deposits. To optimize these pulses for de-fouling while avoiding material or performance degradation, a downstream pressure drop may be introduced to shape the peak pressures and flow rates. Such a pressure drop may be implemented using an orifice restriction, tuned piping, a control valve, or similar flow-control devices.

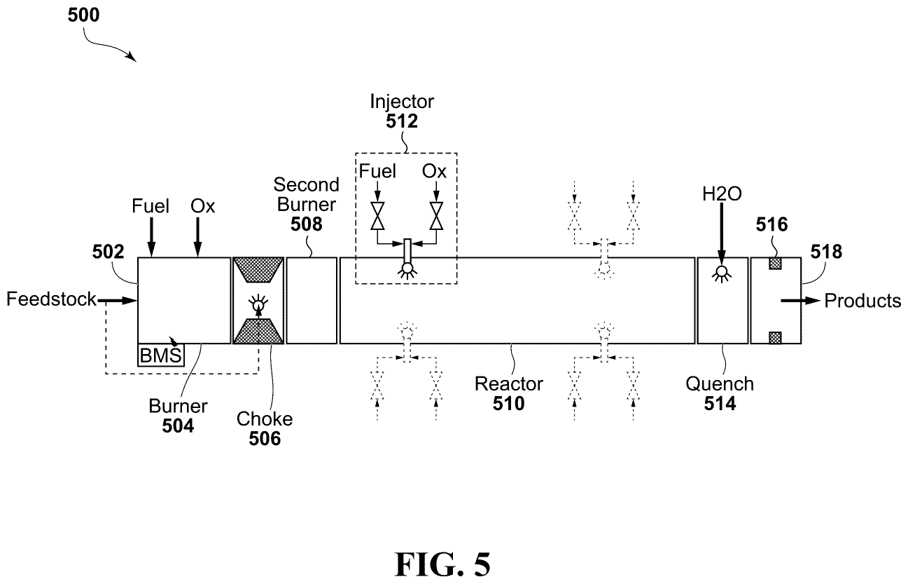

A further example of a steady-flow reactor that may be used with the embodiments described is shown schematically in FIG. 5.

As can be seen in FIG. 5, a steady-flow reactor 500 is configured such that a pre-heated feedstock gas is continuously flowed under pressure along reactor 500, from an inlet 502 to an outlet 518. Reactor 500 includes a burner 502 at an upstream end thereof. A fuel and an oxidant (such as pure oxygen or air) are delivered to burner 504 which generates combustion products from the fuel-oxidant mixture. For example, a burner management system (BMS) may have an ignitor to trigger combustion of the fuel-oxidant mixture so auto-ignition temperatures are not required to start the flame. The fuel may be feedstock or any combustible mixture (e.g., recycled syngas). According to some embodiments, the burner may use a trapped vortex mixer as described in Patent Cooperation Treaty Publication No. WO 2024/124325.

The combustion products pass through a choke 506 which constricts the flow passage and acts as a nozzle to accelerate the flow of combustion products into a reaction chamber or zone 510. According to some embodiments, instead of or in addition to entering reactor 500 at inlet 502, feedstock may also be delivered radially to the longitudinal axis of reactor 500 at choke 506. By increasing the fluid speed, choke 506 may improve mixing of the combustion products with the feedstock. Depending on the stoichiometry of the fuel-oxidant mixture, secondary combustion (“second burner”) may take place immediately downstream of choke 506, in mixing zone 508, as the oxidant-rich mixture mixes with feedstock injected in choke 506.

After exiting choke 506, the combustion products mix with the feedstock in a mixing zone 508 immediately downstream of choke 506. As described above, mixing of the combustion products with the pre-heated feedstock drives pyrolysis of the feedstock. The decomposition continues until the flow of feedstock reaches a quench 514 at which the reaction is stopped, for example by introducing water or some other coolant to the feedstock, or by depressurizing the reaction. The reaction products are extracted at the downstream end of reactor 500.

The specific reaction products that are produced are a function of the “residence time” which is the average duration of time that the feedstock and combustion product mixture spends in reaction zone 510 (which includes mixing zone 508) extending between choke 506 and quench 514. The residence time depends in particular on the rate of flow of feedstock along reactor 500 and the length of reaction zone 510.

Optionally, one or more fuel-oxidant injectors 512 are provided along the length of reaction zone 510. Each injector 512 is configured to inject a fuel-oxidant mixture through a nozzle that sprays the mixture into reaction zone 510. The mixture combusts in response to mixing with the pre-heated feedstock. The combustion generates further combustion products that further drive pyrolysis of the feedstock.

According to some embodiments, instead of using fuel-oxidant injectors 512, the injectors may be configured to inject only an oxidant into reaction zone 510.

According to some embodiments, back-pressure control 516 may be used to maintain an elevated reactor pressure, enabling pulsed pressure via pulsed injection. Such control may be achieved using a valve, orifice, pipe section, or flow constriction, for example, as described herein.

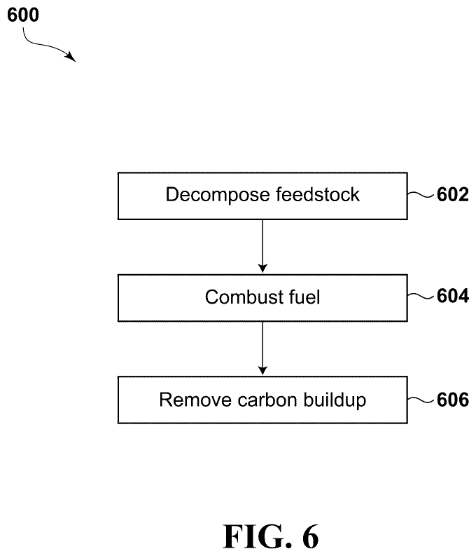

FIG. 6 is a flow diagram showing an example method of mitigating carbon fouling in a feedstock reactor, according to the embodiments described herein.

At block 602, a feedstock is decomposed in a reaction chamber, for example by pyrolysis driven by thermal contact with combustion products.

At block 604, a fuel is combusted. For example, the fuel may be combusted in a combustor that is off-board the reaction chamber, or a portion of the feedstock may be combusted within a burner coupled to the reaction chamber. The combustion may be continuous or pulsed, and may be carried out in the presence of an oxidant such as air or oxygen.

At block 606, carbon buildup is removed as a result of the fuel combustion. For example, the combustion may generate combustion products, pressure pulses, or acoustic excitations that dislodge carbon deposits from internal reactor surfaces. In some embodiments, removal may further be achieved by pulsing the fuel or oxidant to excite a natural or engineered acoustic mode of the reactor, or by operating the reactor in a sealed state and subsequently depressurizing the chamber to flush out accumulated carbon.

In all embodiments described herein, operation of the reactor's various valves may be controlled by a suitable controller (such as a microprocessor) comprising circuitry. The controller (not shown), or some other controller, may control the flow of feedstock, oxidant, and/or fuel into the reaction chamber by controlling valves and compressors or similar devices, for example.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of mitigating carbon fouling in a feedstock reactor, comprising:
decomposing by pyrolysis a hydrocarbon feedstock in the reactor to produce reaction products including solid carbon, wherein at least some of the solid carbon builds up within the reactor; and
removing buildup of the solid carbon within the reactor by combusting a fuel.

2. The method of claim 1, wherein decomposing the hydrocarbon feedstock comprises:
continuously flowing the hydrocarbon feedstock through the reactor; and
injecting a hot fluid into the flow of hydrocarbon feedstock, wherein heat is transferred from the hot fluid to the hydrocarbon feedstock to cause decomposition of the hydrocarbon feedstock.

3. The method of claim 2, wherein:
the fuel is a first fuel; and
injecting the hot fluid comprises:
combusting a second fuel to generate combustion products; and
injecting the combustion products into the flow of hydrocarbon feedstock.

4. The method of claim 1, wherein combusting the fuel comprises:
combusting the fuel in one or more combustors connected to the reactor to generate combustion products that flow from the one or more combustors and into the reactor.

5. The method of claim 2, wherein combusting the fuel comprises:
combusting the fuel in one or more combustors connected to the reactor downstream of a location at which the hot fluid is injected into the flow of hydrocarbon feedstock.

6. The method of claim 1, wherein:
the reaction products further include syngas; and
combusting the fuel comprises combusting at least some of the syngas.

7. The method of claim 1, wherein:
the method further comprises, prior to decomposing the hydrocarbon feedstock, pre-heating the hydrocarbon feedstock; and
decomposing the hydrocarbon feedstock comprises mixing the pre-heated hydrocarbon feedstock with an oxidant to trigger combustion of a first portion of the pre-heated hydrocarbon feedstock to generate combustion products, wherein heat is transferred from the combustion products to a second portion of the pre-heated hydrocarbon feedstock and causes decomposition of the second portion of the pre-heated hydrocarbon feedstock.

8. The method of claim 1, wherein removing buildup of the solid carbon comprises:
loading the reactor with fresh hydrocarbon feedstock, wherein the fresh hydrocarbon feedstock is the fuel;
sealing the reactor with the fresh hydrocarbon feedstock loaded therein;
combusting the fresh hydrocarbon feedstock in the sealed reactor; and
after combusting the fresh hydrocarbon feedstock, depressurizing the reactor to remove the buildup of solid carbon.

9. The method of claim 1, wherein removing the buildup of solid carbon within the reactor comprises:
monitoring the buildup of solid carbon within the reactor; and
combusting the fuel in response to the monitored buildup exceeding a threshold.

10. The method of claim 1, wherein removing the buildup of solid carbon comprises:
pulsing the combustion of the fuel to excite one or more acoustic modes of the reactor to remove the buildup of the solid carbon within the reactor.

11. The method of claim 10, wherein:
the reactor comprises one or more natural acoustic modes; and
pulsing the combustion of the fuel comprises pulsing the combustion of the fuel at one or more frequencies selected to excite the one or more natural acoustic modes.

12. The method of claim 10, wherein pulsing the combustion of the fuel comprises:
monitoring the buildup of the solid carbon within the reactor; and
pulsing the combustion of the fuel in response to the buildup exceeding a threshold.

13. The method of claim 12, wherein:
monitoring the buildup comprises monitoring a pressure drop across the reactor; and
pulsing the combustion of the fuel comprises pulsing the combustion of the fuel in response to the pressure drop exceeding a threshold.

14. The method of claim 10, wherein pulsing the combustion of the fuel comprises:
mixing a flow of the fuel with an oxidant; and
pulsing the flow of the fuel during the mixing.

15. The method of claim 10, wherein pulsing the combustion of the fuel comprises:
mixing the fuel with a flow of an oxidant; and
pulsing the flow of the oxidant during the mixing.

16. The method of claim 10, wherein removing the buildup of solid carbon further comprises:
flowing fresh pre-heated hydrocarbon feedstock through the reactor, wherein the fresh pre-heated hydrocarbon feedstock is the fuel; and
flowing an oxidant into the flow of pre-heated hydrocarbon feedstock, wherein a portion of the pre-heated feedstock is combusted in response to coming into thermal contact with the oxidant.

17. The method of claim 16, wherein removing the buildup of solid carbon further comprises:
pulsing the flow of the oxidant.

18. The method of claim 10, wherein at least one of the one or more acoustic modes is based on at least one choke point introduced in the reactor.

19. The method of claim 18, wherein:
the method further comprises introducing the at least one choke point to the reactor; and
pulsing the combustion of the fuel comprises pulsing the combustion of the fuel to excite the at least one acoustic mode based on the at least one introduced choke point.

20. A feedstock reactor comprising:
a burner for combusting a fuel and an oxidant to generate combustion products;
a choke downstream of the burner to accelerate a flow of the combustion products into a reaction chamber downstream of the choke; and
a computer controller configured to:
control valving to control a flow of a hydrocarbon feedstock into the reaction chamber, wherein at least some of the feedstock, in response to mixing with the combustion products, is decomposed by pyrolysis into reaction products including solid carbon, wherein some of the solid carbon builds up within the reaction chamber; and
control valving to control a flow of an oxidant into the reaction chamber to mix the oxidant with the hydrocarbon feedstock such that at least some of the hydrocarbon feedstock combusts in response to mixing with the oxidant and thereby removes buildup of the solid carbon.

21. A feedstock reactor comprising:
a burner for combusting a fuel and an oxidant to generate combustion products;
a choke downstream of the burner to accelerate a flow of the combustion products into a reaction chamber downstream of the choke;
one or more offboard combustors connected to the reaction chamber; and
a computer controller configured to:
control valving to control a flow of a hydrocarbon feedstock into the reaction chamber, wherein at least some of the feedstock, in response to mixing with the combustion products, is decomposed by pyrolysis into reaction products including solid carbon, wherein some of the solid carbon builds up within the reaction chamber; and
control the one or more combustors to combust a fuel-oxidant mixture in each combustor to generate combustion products that flow into the reaction chamber and remove the buildup of solid carbon.
